(19) United States
(12) Patent Application Publication
(10) Pub. No.: US 2014/0120015 A1
(43) Pub. Date: May 1, 2014

(54) DESORPTION VIA A TRANSPORTING DESORPTION UNIT FOR THE RECOVERY OF CO2 FROM A GAS STREAM AND A RELATED APPARATUS

(71) Applicants: Robert James Perry, Niskayuna, NY (US); Paul William Buckley, Ballston, NY (US); Gary Stephen Balch, Milton, NY (US); Benjamin Rue Wood, Niskayuna, NY (US); Tiffany Elizabeth Pinard Westendorf, Troy, NY (US); Norberto Silvi, Clifton Park, NY (US)

(72) Inventors: Robert James Perry, Niskayuna, NY (US); Paul William Buckley, Ballston, NY (US); Gary Stephen Balch, Milton, NY (US); Benjamin Rue Wood, Niskayuna, NY (US); Tiffany Elizabeth Pinard Westendorf, Troy, NY (US); Norberto Silvi, Clifton Park, NY (US)

(73) Assignee: GENERAL ELECTRIC COMPANY, Schenectady, NY (US)

(21) Appl. No.: 13/664,813

(22) Filed: Oct. 31, 2012

(51) Int. Cl. B01D 53/14; B01D 53/18

(52) U.S. Cl. CPC B01D 53/1425; B01D 53/18
USPC 423/228; 422/168; 423/220

(57) ABSTRACT

A method for recovering carbon dioxide (CO₂) from a gas stream is disclosed. The method includes the step of reacting CO₂ in the gas stream with fine droplets of a liquid absorbent, so as to form a solid material in which the CO₂ is bound. The solid material is then input to a transporting desorption unit, where a decarboxylation reaction takes place, to release substantially pure CO₂ gas. The CO₂ gas can then be collected and used or transported in any desired way. The transporting desorption unit includes an upstream section at atmospheric pressure and a downstream section at a pressure greater than atmospheric pressure, wherein the upstream section and the downstream section are separated by a hydraulic dynamic seal. A related apparatus including the transporting desorption unit for recovering carbon dioxide (CO₂) from a gas stream is also described herein.

### STATEMENT REGARDING FEDERALLY SPONSORED RESEARCH & DEVELOPMENT

This disclosure was made with Government support under contract number NETL DE-AR0000084, awarded by the Department of Energy. The Government has certain rights in the disclosure.

### BACKGROUND

This disclosure generally relates to processes for capturing carbon dioxide (CO₂) from gas streams that contain a mixture of constituents.

The emission of carbon dioxide into the atmosphere from industrial sources such as power plants is now considered to be a principal cause of the “greenhouse effect”, which contributes to global warming. In response, tremendous efforts are underway to reduce emissions of CO₂. Many different processes have been developed to attempt to accomplish this task. Examples include polymer and inorganic membrane permeation; removal of CO₂ by adsorbents such as molecular sieves; cryogenic separation; and scrubbing with a solvent that is chemically reactive with CO₂, or which has a physical affinity for the gas.

One technique has received much attention for removing CO₂ from flue gas streams, e.g., exhaust gas produced at power plants. In this technique, aqueous solutions of monoethanolamine (MEA) or hindered amines like methyldiethanolamine (MDEA) and 2-amino-2-methyl-1-propanol (AMP) are employed as the solvents in an absorption/stripping type of regenerative process. This process has been used commercially for sour gas sweetening and several demonstration plants have been built for CO₂ capture from coal fired power plants.

There are certainly considerable advantages inherent in the MEA and hindered amine-based absorption processes. However, a number of deficiencies may be preventing wider adoption of this type of technology. For example, the CO₂ absorption can sometimes result in sharp increases in the viscosity of the liquid absorbent, which can cause clogging of pipelines. To avoid this problem, the concentration of MEA and other amines is sometimes maintained at a relatively low level, e.g., below about 30 wt. % in the case of MEA. However, the lower concentrations can greatly reduce absorbing capacity, as compared to the theoretical capacity of the neat absorbent.

Moreover, energy consumption in the MEA process can be quite high, due in large part to the need for solvent (e.g., water) heating and evaporation. For example, the process may consume about 10-30% of the steam generated in a boiler that is heated by combustion of a fossil fuel. Furthermore, MEA-based absorption systems may not have the long-term thermal stability, in the presence of oxygen, in environments where regeneration temperatures typically reach at least about 120° C.

Additional drawbacks may result from the fact that the liquid absorbent that is enriched with CO₂ in the MEA or hindered amine process may still contain a substantial amount of free amine and solvent (usually water). The amine and water are removed in the vapor phase under thermal desorption, but can cause corrosion and other degradation in the attendant equipment. To address this concern, specialized, corrosion-equipment materials can be used for the equipment, but this can in turn increase capital costs for the plant. In some cases, corrosion inhibitors can be added, but the use of these specialized additives can also increase operational costs. Moreover, the oxidation of the MEA or hindered amine absorbents can acidify some of the solvents present. In addition to the corrosion problems which can result, this may decrease the available alkalinity for CO₂ capture, thereby reducing process efficiency.

Another example of a commercial CO₂ post-combustion capture process uses aqueous solutions of piperazine-promoted potassium carbonate (K₂CO₃). However, this process is often very energy-intensive, and can be economically inferior to the MEA process. Still another example involves the use of chilled ammonia. In this case, energy-intensive cooling systems are usually required for such a system, and the risks associated with unintended ammonia release may be unacceptable.

In view of these considerations, new methods for treating gas streams that contain CO₂ would be welcome in the art. The new processes should effectively remove some portion of CO₂ from the gas stream, under conditions that are economically viable in some industrial settings, including the ability to decrease the footprint of the capture operation. Moreover, the processes should be compatible with related systems, e.g., power generation systems based on gasification, combustion, and the like.

### BRIEF DESCRIPTION

One embodiment of this disclosure is directed to a method for recovering carbon dioxide (CO₂) from a gas stream. The method comprises reacting CO₂ in the gas stream with fine droplets of a liquid absorbent, so as to form a solid material in which the CO₂ is bound. The solid material is next delivered to a transporting desorption unit. The solid material is processed in the transporting desorption unit to provide a decarboxylation reaction and release substantially pure CO₂ gas, after which the CO₂ gas is collected.

Another embodiment of the disclosure is directed to a method for recovering carbon dioxide (CO₂) from a gas stream. The method comprises reacting CO₂ in the gas stream with fine droplets of a liquid absorbent, so as to form a solid material in which the CO₂ is bound; delivering the solid material to a transporting desorption unit; and processing the solid material in the transporting desorption unit, to provide a decarboxylation reaction and release substantially pure CO₂ gas. The processing of the solid material comprises conveying the solid material from a feed throat of the transporting desorption unit towards a heating section in the transporting desorption unit; heating the solid material in the heating section to regenerate a liquid siloxane and gaseous CO₂; sealing the transporting desorption unit dynamically so an upstream atmospheric section can be decoupled from a downstream section at high pressure; and pumping the liquid siloxane and gaseous CO₂ mixture out of the transporting desorption unit at a pressure greater than atmospheric pressure; and collecting the CO₂ gas.

Various refinements of the features noted above exist in relation to the various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of the present disclosure without limitation to the claimed subject matter.

### BRIEF DESCRIPTION OF THE DRAWINGS

The embodiments set forth in the drawings are illustrative and exemplary in nature and not intended to limit the embodiments defined by the claims. The following detailed description of the illustrative embodiments can be understood when read in conjunction with the following drawings, where like structure is indicated with like reference numerals and in which:

FIG. 1 is a schematic of an exemplary apparatus for recovering CO₂ from a gas stream according to one or more embodiments shown or described herein;

FIG. 2 is a schematic of another exemplary apparatus for recovering CO₂ from a gas stream according to one or more embodiments shown or described herein;

FIG. 3 is a schematic of an exemplary test transporting desorption unit for recovering CO₂ from a gas stream according to one or more embodiments shown or described herein; and

FIG. 4 is a schematic of an exemplary transporting desorption unit for recovering CO₂ from a gas stream according to another embodiments shown or described herein.

### DETAILED DESCRIPTION

The compositional ranges disclosed herein are inclusive and combinable (e.g., ranges of “up to about 25 wt %”, or, more specifically, “about 5 wt % to about 20 wt %”, are inclusive of the endpoints and all intermediate values of the ranges). Weight levels are provided on the basis of the weight of the entire composition, unless otherwise specified; and ratios are also provided on a weight basis. Moreover, the term “combination” is inclusive of blends, mixtures, alloys, reaction products, and the like. Furthermore, the terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The modifier “about” used in connection with a quantity is inclusive of the stated value, and has the meaning dictated by context, (e.g., includes the degree of error associated with measurement of the particular quantity). The suffix “(s)” as used herein is intended to include both the singular and the plural of the term that it modifies, thereby including one or more of that term (e.g., “the compound” may include one or more compounds, unless otherwise specified). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described inventive features may be combined in any suitable manner in the various embodiments.

As further described herein, carbon dioxide is present in a wide variety of gas streams which can be treated according to embodiments of this disclosure. Non-limiting examples include gas streams originating from a combustion process; a gasification process; a landfill; a furnace (e.g., blast furnace or chemical reduction furnace); a steam generator; a boiler; and combinations thereof. In some embodiments, the CO₂ gas stream is a flue stream originating in a coal-fired power plant. In other embodiments, the CO₂ gas stream originates in a coal gasification plant, exemplified by an integrated gasification combined cycle (IGCC) plant. In addition to CO₂, the flue stream can include a number of other constituents, such as oxygen, nitrogen, argon, carbon monoxide, nitrogen oxygen compounds, sulfur compounds (e.g., sulfur dioxide, carbonyl sulfide); soot particles, and water vapor.

A variety of liquid absorbents can be reacted with the carbon dioxide. In general, any liquid CO₂ absorbent that can be converted to a solid by reaction with carbon dioxide can be used to carry out the process described herein. Some of the liquid absorbents are described in the following references: “Reversible Gelation of Polyethyleneimide Solutions Using CO₂”, Kitchens et al, AIChE Annual Meeting, San Francisco, Calif., 2006 (p. 520f of proceedings); and “Reversible, Room-Temperature Chiral Ionic Liquids. Amidinium Carbamates Derived From Amidines And Aliphatic Primary Amines With Carbon Dioxide”, Yamada et al, Chem. Mater., 19, (5), 967-969 (2007).

Usually, the liquid absorbent comprises at least one amine material. Various amine compounds (the term as used herein includes polymeric materials as well) are suitable. Many fall into the following classes: aliphatic primary, secondary and tertiary amines, and polyamines; polyimines (e.g., polyalkyleneimines); cyclic amines, amidine compounds; hindered amines; amino-siloxane compounds; amino acids; and combinations thereof. Non-limiting examples of these materials are noted below.

Exemplary aliphatic amines and polyamines are cyclohexyl amine, ethylenediamine, diethylenetriamine, triethylenetetramine, tetraethylenepentamine, and the like. Moreover, materials such as substituted amines, for example alkanolamines, may also be used.

Exemplary polyimines are the polyalkyleneimines. Many of these materials are obtained by the polymerization of one or more alkyleneimines, such as ethyleneimine, propyleneimine, and 1,2-butyleneimine. In some embodiments, the preferred polyimine is polyethylenimine.

Illustrative cyclic amines include piperidine, piperazine and pyridine-based compounds such as 4-aminopyridine. Various bicyclo compounds can also be used, such as 1,5-diazabiciclo [4.3.0]non-5-ene (DBN) or 1,8-diazabiciclo [5.4.0]undec-7-ene (DBU).

A number of amidine and guanidine compounds may also be used. Most of amidines conform to the general structure

RC(—NR)NR2,

wherein each R group, individually, can be hydrogen or a lower alkyl group. Many of the amidine compounds are considered to be oxoacid derivatives. (When the parent oxoacid is a carboxylic acid, the resulting amidine is a carboxamidine). Some of the amidine compounds are described in U.S. Pat. No. 4,162,280 (Kranz) and U.S. Pat. No. 4,129,739 (Tracy et al). Each of these references is incorporated herein by reference. Non-limiting examples of the amidines include formamidine (HC(—NH)NH2).

Guanidines are a group of organic compounds with the general structure (R1R2N)(R3R4N)C—N—R5, wherein each “R” group can independently be hydrogen or an alkyl group. Non-limiting examples of the guanidines include 1,1,3,3-tetramethylguanidine ((Me2)N)2C—NH).

Hindered amine compounds which may be used as the liquid absorbent are also known in the art. Some of these compounds are described in U.S. Pat. No. 4,405,579 (Sartori et al) and U.S. Pat. No. 6,117,995 (Zedda et al), as well as EP Application 0588175B1 (Yoshida et al). Each of these references is incorporated herein by reference. Non-limiting examples include polyalkyl-substituted piperidine derivatives, such as 2,2,6,6-tetramethyl piperidine. Other examples include 2,2,6,6-tetramethyl piperidine; tert-butylamine; cyclohexyldiamine; 2-(dimethylamino)-ethanol; 2-(diethylamino)-ethanol; 2-(ethylmethylamino)-ethanol; 1-(dimethylamino)-ethanol; 1-(diethylamino)-ethanol; 1-(ethylmethylamino)-ethanol; 2-(diisopropylamino)-ethanol; 1-(diethylamino)-2-propanol; 3-(diethylamino)-1-propanol; and combinations thereof.

Amino-siloxane compositions are also known in the art. Various types of these compounds are described in U.S. Pat. No. 5,939,574 (Schilling, Jr., et al) and U.S. Pat. No. 4,487,883 (Homan), which are incorporated herein by reference. Those skilled in the art will be able to determine which particular amino-silixoxanes are capable of reacting with gaseous CO₂ to form the solid material, as described herein. Some of the amino-siloxanes which are useful for this disclosure are described in a pending U.S. Pat. No. 8,030,509 (Perry), which is incorporated herein by reference. A variety of amino-siloxanes are described in the referenced disclosure. Non-limiting examples of suitable amino-siloxanes include compositions which comprise chemical structure (I)

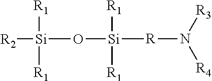

wherein R is a C1-C6 alkyl group, which can be linear or branched; and which can contain at least one hydroxy group; R1 is independently at each occurrence C1-C8 alkyl or aryl; R2 is R1 or RNR3R4, wherein R3 and R4 are independently a bond, hydrogen, or C1-C8 alkyl (linear or branched).

One specific, illustrative example of an amino-siloxane compound is provided below as compound (Ia), wherein “Me” is a methyl group:

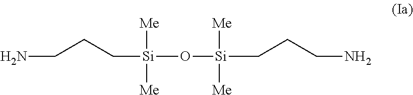 [SMILES: C[Si](C)(CCCN)O[Si](C)(C)CCCN]

U.S. Pat. No. 8,030,509 describes methods for preparing various amino-siloxane compounds as well.

The identity of the solid material which is formed by reaction of the liquid absorbent with the CO₂ will depend in large part on the specific liquid absorbent that is used.

In the case of amine absorbents, the solid material will depend on the identity of the amine. In many instances, the solid material comprises a carbamate or a bicarbonate compound, or a combination thereof.

The reaction of the liquid absorbent with the amine compound can be carried out in any large-scale chamber or enclosure. The particular type of chamber is not critical to this disclosure, as long as it allows for sufficient contact between the CO₂ and the liquid absorbent and allows for separation of the solid absorbent—CO₂ complex. Thus, the enclosure can be in the form of an absorption tower, a spray tower, or a venturi scrubber, optionally equipped with an entrainment separator. Moreover, while a vertical chamber is depicted in the figures discussed below, a horizontally-oriented chamber might alternatively be used.

As an example, venturi scrubbers are known in the art, and typically include at least three sections: a converging section, a throat section, and a diverging section. An inlet gas stream can enter the converging section, and as the area decreases, gas velocity increases. Liquids are usually introduced at the throat, or at the entrance to the converging section. In a typical scenario, the inlet gas is forced to move at very high velocities in the small throat section, shearing the liquid matter from the vessel walls. This action can produce a large number of very tiny droplets, which can react with the inlet gas stream. As one non-limiting example, venturi systems are described in U.S. Pat. No. 5,279,646 (Schwab), which is incorporated herein by reference.

In some embodiments of this disclosure, the use of a spray tower is preferred. Spray towers and absorption towers are well-known in the art, and described in many references. Several illustrations include U.S. Pat. No. 7,368,602 (Sakai et al); U.S. Pat. No. 5,206,002 (Skelley et al); and U.S. Pat. No. 4,114,813 (Suga), all of which are incorporated herein by reference.

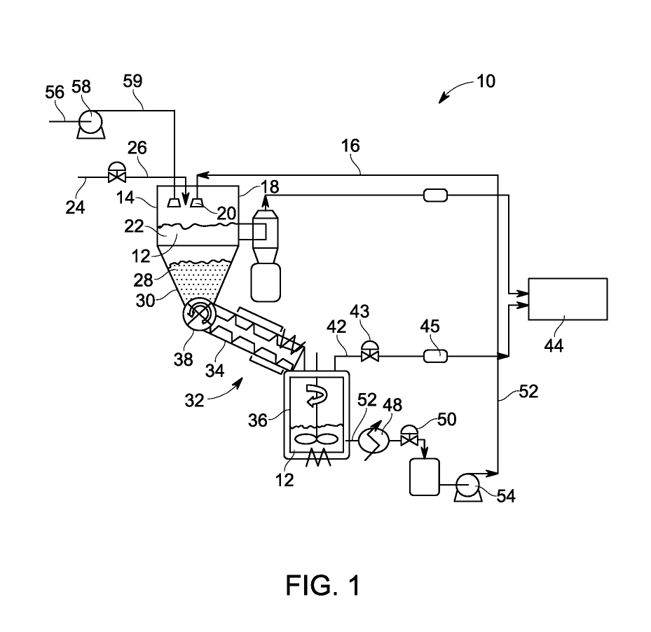

FIG. 1 is a simplified, non-limiting description of one apparatus 10 for carrying out the process according to embodiments of this disclosure. The liquid absorbent 12 is directed from any suitable source (not shown) into spray tower 14, via at least one conduit 16. The supply point for the absorbent is usually located in an upper region 18 of the spray tower 14, to ensure fine droplet formation of the absorbent, as described below, and to provide sufficient contact time with the CO₂. The supply point for the absorbent may be also located above or in the narrow (throat) part of a venturi scrubber. An absorbent atomizing means 20 is employed to disperse the absorbent into droplets.

A variety of conventional atomizing mechanisms may be used, such as spray atomization. In the illustrated embodiment, the atomizer 20 is incorporated into a portion of the conduit 16. The atomizing mechanism would typically be located near the exit of conduit 16 into the tower 14, and more than one nozzle tube could be used as well. More specifically, the atomizing mechanism 18 would typically be located in an interior 22 of the tower 14. In an alternate embodiment, air or some another atomizing gas can be supplied from a nozzle tube into the interior 22 of the tower 14. In some embodiments, many nozzles may be placed across the tower at different heights, to maximize the number of the absorbent droplets. Hydraulic atomizers and rotary atomizers may also be employed.

The selected size for the droplets of liquid absorbent will depend on various factors, such as the composition of the absorbent; the reactivity of the absorbent material with CO₂ gas; and the type and design of the absorption chamber. In general, the droplets should be small enough to collectively provide a maximum surface area for contact with the CO₂. In this manner, a relatively high proportion of the CO₂ can be removed from the gas stream. Moreover, the relatively small droplet size will help to ensure that the droplet particles are less prone to “stickiness”, which could otherwise impede movement and suspension of the droplets. However, the droplets should be large enough to provide a sufficient mass for solid particle formation, as described below, and to prevent formed solid particles from being carried out of the tower. As a non-limiting example for an amine-based absorber used in a spray tower, the droplets may be best described as fine droplets, wherein an average diameter of the droplets is usually no greater than about 1000 microns, and typically, in the range of about 10 microns to about 100 microns. In another embodiment when a venturi scrubber is used, the average diameter of the droplets is typically in the range of about 10 microns to about 100 microns.

With continued reference to FIG. 1, flue gas 24 is directed into spray tower 14 by any suitable conduit 26. In some embodiments (though not all), the flue gas is directed into a lower region 28 of the spray tower, relative to upper region 18. In this manner, an induced countercurrent flow exposes the outlet gas (described below) having the lowest CO₂ concentration to the freshest absorbent. At the same time, the inlet gas with the highest CO₂ concentration is exposed to the most “converted” absorbent. This type of flow scheme can permit the resulting solid particles to agglomerate more readily, leading to more efficient solids collection from the absorber.

The flow rate of the flue gas entering chamber 14 is maintained to provide the required residence time for the complete reaction, as described below. The inlet pressure depends on the design of the absorption chamber. The pressure drop for the flue gas entering the chamber may be relatively small in the case of a spray tower (e.g., about 1 inch (2.54 cm) of water), but may be larger for other types of absorption towers.

Contact between the CO₂ gas molecules and the liquid absorbent droplets results in the formation of solid particles 30, as mentioned previously. CO₂ is chemically bound within the particles. The size, shape, and density of the particles depend on various factors, such as the size of the initial droplets; the content of the liquid absorbent; the residence time within the spray tower or other type of chamber; and the gas flow rate. The particles 30 should be small enough to solidify to at least a non-sticky surface texture, but large enough to provide a sufficient mass for effective disengagement from the gas stream and transport out of the spray tower 14. Usually, particles 30 are spherical, or substantially spherical in shape. Their average density can vary significantly, but is usually in the range of about 1.1 g/cc to about 1.5 g/cc. The size of the particles can vary, e.g., depending on the initial spray technique used. In some instances, the average particle size is in the range of about 30 microns to about 500 microns.

Formation of solid particles 30 can remove a substantial amount of “free” CO₂ from the gas stream, e.g., at least about 50% by volume in some embodiments, and at least about 70% by volume, in other embodiments. The remaining, CO₂-lean flue gas can then be released as an outlet gas, via any suitable conduit or directed to other locations for additional treatment or use.

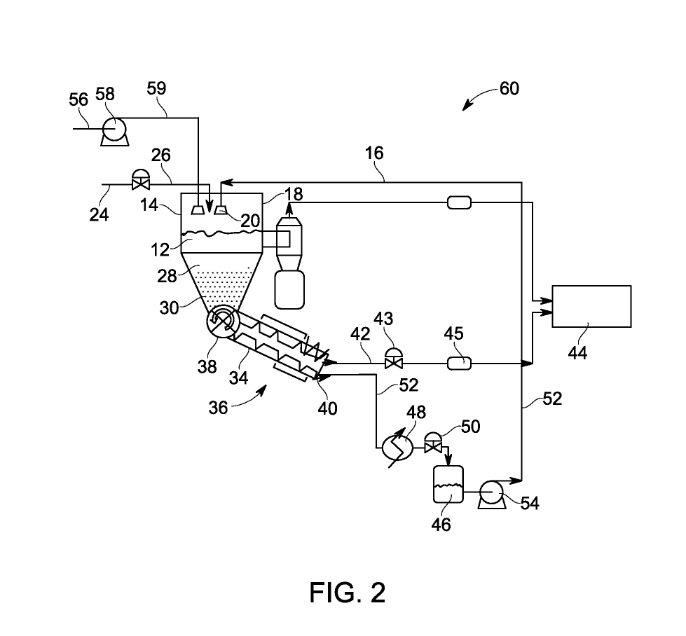

In an embodiment, the particles are then transported via a transportation mechanism 32, and more particularly, a transporting desorption unit 34, to a secondary desorption station 36. More specifically, in the embodiment, illustrated in FIG. 1, the transportation mechanism 32 functions as both a transporting means and a desorption unit. A separate, secondary desorption station 36, positioned downstream of the transporting desorption unit 34, is also included in the apparatus 10. In an alternate embodiment (described presently), and as best illustrated in FIG. 2, the apparatus 10 includes a transporting desorption unit 34 without the inclusion of a secondary desorption unit positioned downstream.

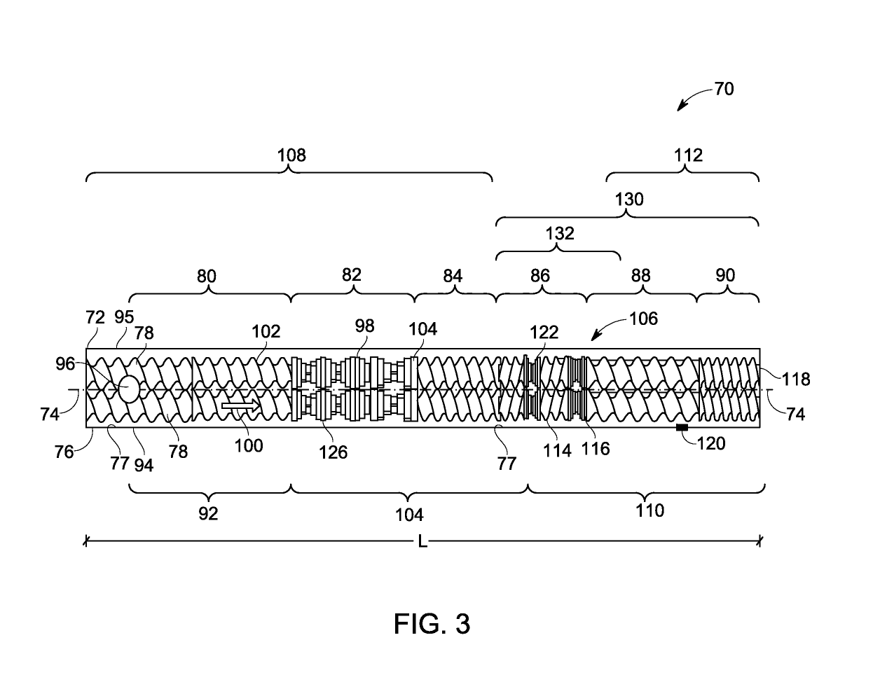

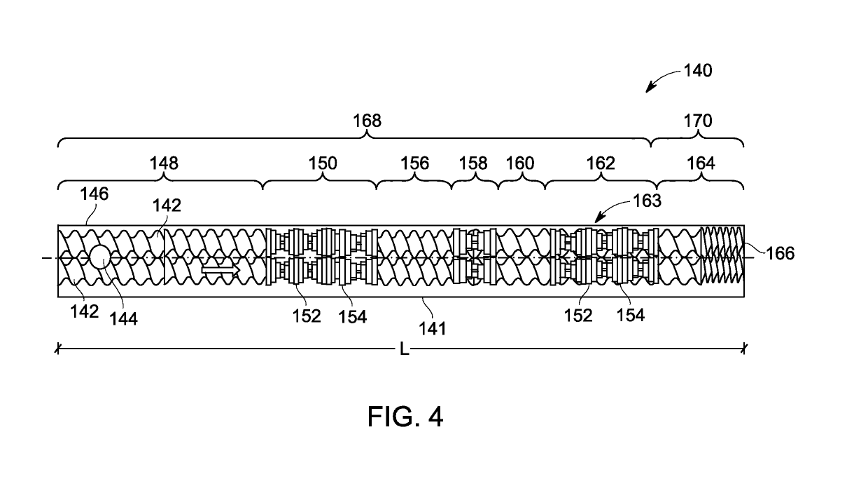

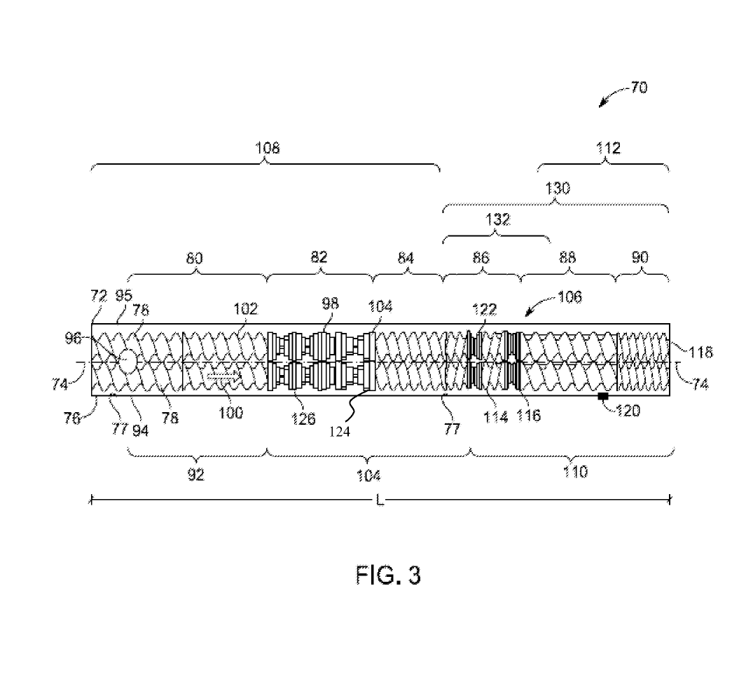

With reference again to exemplary FIG. 1, solid particles 30 can exit spray tower 14 through any practical opening (not shown). The particles can then drop or be directed, such as by a rotary hopper 38, into the transportation mechanism 34, and more particularly the transporting desorption unit 36. In one embodiment of this invention, the transporting desorption unit 36 includes an absorption chamber upstream and a pressure unit downstream to effect the decarboxylation of a carbamate into a free amine and carbon dioxide. The transporting desorption unit 36 employs a screw-type extruder disposed between the absorption chamber and the pressure unit. The extruder can be of the single-screw or twin-screw type, and it will provide the following functions: (i) conveying of the carbamate powder from a feed throat of the extruder towards a die plate; (ii) heating of the powder to regenerate the starting liquid free amine and evolve gaseous CO₂; (iii) sealing of the extruder dynamically so the upstream atmospheric section can be decoupled from the pressurized downstream section; and (iv) pumping of the amine-CO₂ mixture out of the extruder and into the desorption unit maintained at a relatively high pressure. A detailed description of the transporting desorption unit 36 is described herein with reference to FIG. 3.

With continued reference to FIG. 1, the particles 30 upon exiting the transporting desorption unit 36 are directed toward the secondary desorption station 38. The secondary desorption station 38 may comprise any type of desorption unit used to further separate volatile compounds from solid particles. In general, desorption station 38 is a vessel or tube which can provide varying heat and pressure conditions to further liberate CO₂ from the solid particles 30. The station also includes a means for collecting the liberated gas, and separating the gas from any other desorption constituents, e.g., liquid or solid particles.

Desorption units, such as desorption station 38, are described in a number of references. One non-limiting example is the publication “Remediation Technology Health and Safety Hazards: Thermal Desorption”, circulated by the Occupational Safety & Health Administration (OSHA); SHIB 02-03-03 (http://www.osha.gov/dts/shib/shib-02-03-03_tsds9.pdf), which is incorporated herein by reference. Many of the units are referred to as “thermal desorption units”, which are designed to operate at relatively low temperatures, e.g., about 200° F. to 600° F. (93° C.-316° C.); or relatively high temperatures, e.g., about 600° F. to 1,000° F. (316° C.-538° C.).

In terms of applied temperature, thermal desorption units are often grouped into three process types: directly-heated units, indirectly-heated units; and in-situ units, as described in the OSHA reference. Moreover, the configuration of the unit can vary, e.g., depending on what type of solid material is being treated; and what temperature is required. In some instances, the desorption unit can be operated under a vacuum or very low pressure conditions; and/or low-oxygen conditions, to lower the heat requirements needed for desorption. Adjustment of the atmospheric conditions can also provide flexibility in reducing the likelihood of creating hazardous conditions, e.g., the formation of hazardous products, or flammable conditions.

In general, further desorption of the solid particles 30 is typically carried out by this secondary heating of the particles 30 having passed through the transporting desorption unit 34. As alluded to previously, the heat-treatment regimen will depend on the composition and size of the solid particles; the amount of remaining CO₂ bound within the particles; pressure conditions within desorption chamber 38; and the required reaction rate. The temperature should be high enough to release as much CO₂ as possible from the solid particles, and is typically at least as high as the decomposition temperature of the particles. However, the temperature should not be excessively high, i.e., requiring excessive energy use; or possibly resulting in decomposition to byproducts which may be difficult to handle in the overall process. In most embodiments where the solid particles are carbamates, bicarbonates, or related compositions, the desorption temperature is usually in the range of about 80° C. to about 200° C. and more preferably from 100-150 ° C. In some instances, the internal pressure in chamber 36 can be decreased, to accelerate the desorption process.

With continued reference to FIG. 1, the substantially pure CO₂ gas 40 is released or otherwise directed out of desorption chamber 38 by any suitable conduit 42 (or multiple conduits). In some instances, the CO₂ gas is compressed and/or purified, for re-use, or for transport via a back-pressure regulator 43 and a mass flow meter 45 to a location for sequestration 44. Various uses for the CO₂ gas are described in a number of references, e.g., U.S. Pat. No. 7,919,064 (Kawatra et al), which is incorporated herein by reference. In addition, as illustrated in FIG. 1, a stripped flue gas (optional water vapor) cyclone 62 may be included as a part of apparatus 10.

The desorption step, including desorption within both the transporting desorption unit 34 and the secondary desorption chamber 38, also functions to regenerate a substantial amount of the liquid absorbent 12. In an embodiment, the liquid absorbent 12 may be directed toward a reservoir 46, via a chiller 48, and a throttling valve 50. In some embodiments, the liquid absorbent 12 can then be directed to treatment, storage, or disposal facilities (not shown). However, in preferred embodiments, liquid absorbent 12 is directed back to spray tower 14, through one or more conduits 52. One or more pumps 54 can be used to pump the absorbent 12 back to the spray tower 14. However, other techniques for moving the absorbent 12 through appropriate piping can be envisioned by those skilled in the art.

Typically, the regenerated liquid absorbent 12 can be added by itself to the spray tower 14, to react with additional CO₂ from a gas stream, forming more CO₂-bound solid material in a closed loop process. The regenerated liquid absorbent could be combined with “fresh” liquid absorbent (not shown), or could be added to the spray tower 14 as a separate feed, along with a “fresh” liquid absorbent. Moreover, the liquid absorbent 12 could be combined with one or more solvents, such as glycol ethers, e.g., glymes, triethyleneglycol dimethyl ether, or with water 56, via a pump 58 and a conduit 59, to reduce the viscosity of the material which enters the spray chamber 14.

In some instances, the liquid absorbent 12 used for reaction with CO₂ has a relatively high vapor pressure, and is volatile under typical atmospheric conditions. In other instances, small droplets of regenerated absorbents may be carried out of the desorption site with the gas flow. Therefore, it may be desirable to include at least one condensation step in the process. In this manner, additional absorbent may be recovered from the CO₂-lean flue gas, which results after decomposition of the solid CO₂-rich material.

As previously indicated, in an alternate embodiment, as best illustrated in FIG. 2, the apparatus may not include a secondary desorption chamber. More specifically, in the embodiment illustrated in FIG. 2, an apparatus 60 is illustrated. Features that are identical to those of FIG. 1 need not be specifically described, and accordingly like numbers are used to indicate like elements. In the illustrated embodiment of apparatus 60, the transporting desorption unit 34 provides complete desorption for the apparatus 60. As previously indicated with respect to FIG. 1, the transporting desorption unit 34 may be any type of an extruder, which would transport solid particles 30 through all or part of its length. Heating of the particles 30 within the transporting desorption unit 34 liberates carbon dioxide, which can be directed out of the extruder by any suitable outlets. The most appropriate shape, position, and number of outlets can be determined without undue experimentation. As in the other embodiment, the liberated CO₂ can be directed to any desired location, and in this particular embodiment the substantially pure CO₂ gas 40 is released or otherwise directed out of transporting desorption unit 34 by any suitable conduit 42 (or multiple conduits). The liquid absorbent 40 which is regenerated after desorption in the transporting desorption unit 34 can be collected and directed to a desired location. As an example, the absorbent could be directed by conduit 52 to supply conduit 16, for reentry into spray tower 14. Other alternatives for the regenerated material are possible, as noted above, e.g., pre-mixing with fresh absorbent, or direct transport to the spray tower 14. Moreover, this embodiment, like the other, can be combined with various other features disclosed herein. For example, this embodiment could employ the condenser system described above with respect to FIG. 1.

Referring now to FIG. 3, illustrated is a transporting desorption unit 70, generally similar to transporting desorption unit 34 described with reference to apparatus 10 and 60 of FIGS. 1 and 2 that is used to recover CO₂ from a gas stream, and more particularly to convert a carbamate powder at atmospheric pressure into a two-phase siloxane-CO₂ mixture at a relatively high pressure. In an embodiment, such as the apparatus 10 illustrated in FIG. 1, the transporting desorption unit 70 includes a screw-type extruder 72 disposed between an absorption chamber upstream, such as the spray tower 14 of FIG. 1, and a pressure unit downstream, such as the secondary desorption station 36, to effect the decarboxylation of a carbamate into a siloxane and carbon dioxide. Alternatively, and as previously described, the transporting desorption unit 70, includes a screw-type extruder 72 disposed downstream from an absorption chamber, such as the spray tower 14 of FIG. 1, and in direct communication with a reservoir, such as CO₂ reservoir 46 of FIG. 2. In the illustrated embodiment, the extruder 72, having an axis 74, is a twin-screw type and includes an extruder barrel 76 having an interior surface 77 and disposed therein two cooperating screw mechanisms 78. In an alternate embodiment, the extruder 72 may be of the single-screw type. The extruder 72 may be divided into sections indicative of function, and more particularly, divided into a first conveying section 80, a heating section 82, a second conveying section 84, a sealing section 86, a third conveying section 88 and a compression section 90. In the first conveying section 80, the particles 30 as described in FIGS. 1 and 2, and more particularly a carbamate powder, is conveyed from an upstream section 92, and more particularly via a feeding section 94, toward a plurality of kneading blocks 98 in the heating section 82. In an embodiment, the carbamate powder is fed at a throat 95 of the extruder 72 on top of the open conveying screw mechanisms 78. More particularly, the carbamate powder enters the upstream section 92 via a feed port 96. The carbamate powder is transported downstream of the extruder 72, of which a flow direction is indicated by arrow 100, using a plurality of right-handed conveying (helical) elements 102.

In an intermediate section 104 of extruder 72, and more particularly in the heating section 82, the carbamate powder is heated to regenerate the starting liquid siloxane and gaseous CO₂. At this stage in the process, there are three phases coexisting in the extruder 72, namely a solid carbamate phase, and the two phases produced by the reaction, a siloxane liquid phase and a gaseous CO₂ phase.

The second conveying section 84 transports the carbamate powder and siloxane and gaseous CO₂ from the intermediate section 104 toward the sealing section 86 with the aid of a plurality of right-handed conveying (helical) elements 102. In the sealing section 86, the extruder 72 is dynamically sealed, and more particularly a hydraulic dynamic seal 106 is formed, so the upstream section 92 of the extruder at an atmospheric pressure 108 can be decoupled from a downstream section 110 at a high pressure 112. The dynamic sealing takes place by pushing the solid material being processed against the interior surface 77 of the extruder barrel 76 which raises the pressure in the sealing section 86 above atmospheric pressure. This step is necessary since the siloxane-CO₂ mixture needs to be delivered into the downstream desorption chamber 36 (FIG. 1) at greater than 1 bar (˜15 psi), and more specifically at about 6bar (˜90psi) pressure. This sealing effect, which separates the upstream section 92 of the process at atmospheric pressure 108 from the downstream section 110 of the process at a higher pressure 112, is accomplished by the use of a plurality of neutral or left-handed elements in the design of the extruder screws mechanisms 78. More particularly, a plurality of left-handed conveying (helical) elements 114 and a plurality of left-handed kneading blocks 116 are used in combination to generate sufficient back flow so that the pressure can be raised to that required at a discharge 118 of the extruder 72. The strength of the hydraulic dynamic seal 106 thus formed will be determined by the type of left-handed elements used as well as the number of them and the sequence in which they are assembled together.

The third conveying section 88 is then able to convey, or pump, a siloxane-CO₂ mixture out of the extruder 72 at the discharge 118 and into the desorption unit 36 (FIG. 1) maintained at a relatively high pressure or alternatively to a reservoir 46 (FIG. 2).

The extrusion process will be designed so that the extruder 72 will be capable of handling a fine powder in an upstream section 92 of the extruder 72, a two-phase liquid-gas system in the downstream section 110 of the extruder 72, and a mixture of solid, liquid and gas in the intermediate section 104 of the extruder 72 where the decarboxylation reaction takes place. The extruder 72 may additionally be equipped with one or more vent ports 120 that can remove the CO₂ produced by the decarboxylation reaction so a liquid partially depleted of CO₂ can be obtained.

An overall length “L” of the extruder 72, number and location of the vent port(s) 120, design of the extruder screw mechanism(s) 78 and kneading blocks 98, and processing conditions, such as feed rate, screw speed, barrel temperature, and distribution of pressure under the vent(s) 120, among others, are parameters that need to be determined experimentally so that the performance of this extrusion process can be optimized.

The elements used to build the first, second and third conveying sections 80, 84, 88, the heating section 82, the sealing section 86, and the compression section 90 of the extruder 72 used for decarboxylation are useful for the generation of the heat needed to effect the reaction, conveying of the liquid-gas mixture of low viscosity along the axis 74 of the extruder 72, and renewal of the liquid-gas interfaces exposed to high temperature and pressure/vacuum under the vent(s) 120. Of particular importance in the design of the screw mechanism(s) 78 used for decarboxylation of carbamate powders in the extruder 72 are the kneading blocks 116, 124, and 126. The kneading blocks 116, 124, and 126 are configured as a collection of profiled disks 122 stacked at an angle with respect to each other and defining a wide crest that forms a wedge with an interior surface 77 of the extruder barrel 76. This wedge promotes heating/melting, mixing and surface renewal. When stacked in opposition to a downstream flow, as are the plurality of left-handed kneading blocks 116, they generate back pressure dynamically, which may be useful in situations where long residence times or sealing of pressure zones is needed. A plurality of right-handed kneading blocks 124, such as those found in heating section 82, move material inside the extruder 72 in the forward direction as indicated by directional arrow 100, from the feeding section 94 of the extruder 72 to the extruder's discharge 118. The right-handed kneading blocks 124 are not only used for forward conveying but also for heat generation thus supplying enough thermal energy to the material so it can be heated and turned into a liquid or melt. In contrast, the plurality of left-handed kneading blocks 116, such as those found in the sealing section 86, stand in opposition to the flow 114 making it more difficult for the material to move forward. A plurality of neutral kneading blocks 126, in which the disks or plates are stacked at 90° angles, such as those found in heating section 82, can be used to generate heat by viscous dissipation and also produce enough back flow to help left-handed kneading blocks 116 seal the process dynamically. The rotating action of kneading blocks, both of the right-handed 124 and 90° neutral types 126, are used to generate enough heat by viscous dissipation to raise the temperature of the solid and thus trigger the decarboxylation reaction. With respect to their strength to oppose the flow and generate back pressure, the left-handed conveying (helical) elements 114, such as those found in sealing section 86, are the most severe (strong back-pumping capability), and the neutral kneading blocks 126 the least severe, with the left-handed kneading blocks 116 standing somewhere in between these two. It is customary in extruder design to use right-handed conveying (helical) elements 102 of tight pitch (flights close together) upstream of the sealing section 86 to accumulate process liquid and thus help in the generation of back pressure in that section of the process. In an embodiment, the screw mechanisms 78 that will be used in this process will have at least 20% of its length occupied by the plurality of right-handed conveying (helical) elements 102 to move the material in the direction of the discharge, 118, and at least 10% of its length with a combination of right-handed kneading blocks 124 and neutral kneading blocks 126 to effect the heating of the material 30 inside the extruder 72. The section of the extruder 72 where the pressure will be raised using a plurality of left-handed (and possibly neutral) kneading blocks and conveying (helical) elements 114 and 116 will be at least 5% of the total length of the screw mechanisms 78. The screw mechanism 78 at the discharge 118, and more particularly in the compression section 90 of the extruder 72 where an additional increase in the pressure takes place, is usually short and occupies not more than about 10% of the total length of the screw mechanisms 78.

In an embodiment, the screw mechanisms 78 of the twin-screw extruder 72 are assembled by coupling together the individual elements sequentially on a screw shaft (not shown). This design is modular and highly flexible since the screw mechanisms 78 can be disassembled and put together again using a different design with relatively little difficulty. The left-handed conveying (helical) elements 114, left-handed kneading blocks 116 and neutral kneading blocks 126 are commonly used in extruders to generate back flow, thus increasing the residence time of the material inside the extruder 72 as well as dynamically sealing the process internally so it can be run at two different pressures before and after the seal 106. However, the selection of the type, and sequence of left-handed screw elements used, as well as the number of them in the design, has to be done carefully since too much “left-handedness” in the screw may restrict the forward flow of material so severely that the material may be forced to flow backwards and in the direction of the extruder's feeding section 94.

The optimization of the extrusion process to decarboxylate a carbamate powder into a siloxane and carbon dioxide delivered from the extruder 72 at relatively high pressures requires the finding of two processing windows, and more particularly, a first window 130 in which only a siloxane-CO₂ mixture can exist (no solid carbamate present) and a smaller second window 132 in which this mixture is held at two different pressures while separated by the hydraulic dynamic seal 106. Screw mechanism design, extruder length, barrel temperature, screw speed and feed rate are expected to play an important role in the optimization of the size of these two processing windows.

### EXAMPLE

The example presented below is intended to be merely illustrative, and should not be construed to be any sort of limitation on the scope of the claimed embodiments disclosed herein.

Referring now to FIG. 4, to demonstrate reduction to practice, GAP-0 carbamate was fed into a PRISM ®, 16 mm diameter, twin-screw mechanism 142 co-rotating intermeshing extruder 140 equipped with a loss-in-weight feed port 44 to accurately add the carbamate powder to the feed throat 146 of the extruder 140. The extruder's screw design used in this experiment is shown in FIG. 4. The twin-screw mechanisms 142 includes a conveying zone 148 upstream (7D long, where D is the diameter of the extruder 140 equal to 16 mm, with conveying helical screw mechanisms 142), a heating zone 150 (3D long) including a plurality of right-handed kneading blocks 152 and a plurality of neutral kneading blocks 154, a second conveying zone (3.5D long) 156, a second heating zone (1D long) 158, a third conveying zone (3D long) 160, a sealing zone (3D long) 162 including a plurality of right-handed kneading blocks 152 and a plurality of neutral kneading blocks 154, and a conveying/compression zone (4.5D long) 164 at a discharge 166 of the extruder 140. In the sealing zone 162, the extruder 140 is dynamically sealed, and more particularly a hydraulic dynamic seal 163 is formed, so an upstream section 168 of the extruder 140 at an atmospheric pressure can be decoupled from a downstream section 170 at a high pressure. The conveying zones 148, 156, 160 represent approximately 66% of a length “L” of the extruder 140, the heating zones 75, 79 represent approximately 16% of a length “L” of the extruder 140, the sealing zone 81 represents approximately 12% of a length “L” of the extruder 140, and the compression zone 82 represents approximately 6% of a length “L” of the extruder 140. The extruder 140 having an overall L of approximately 25D. The twin-screw mechanisms 142 contained no left-handed elements, either of the conveying/helical or kneading block types. The extruder 140 was run at various screw speeds and feed rates to adjust the residence time as well as the internal volume of material inside the extruder 140. The temperature profile of a barrel 141 of the extruder 140 was as described in the table below. This allowed compaction of the carbamate solid in the front portion of the extruder 140 prior to heating in the middle and end portions. As the carbamate was transported through the extruder 140, the material was heated which allowed decarboxylation to occur. The decarboxylated amino silicone and desorbed CO₂ were delivered into a pressure vessel (secondary desorption station 36 of FIG. 1) where the pressure was recorded. Pressures in excess of atmospheric were achieved and analysis of the resulting material delivered to the pressure vessel indicated that 50-73% decarboxylation had occurred.

| | | | | | | | | | Parr |
|---|---|---|---|---|---|---|---|---|---|
| | Barrel Set Temps (° C.) | | | | | Screw Speed | Feed Rate | Die Pressure | Pressure |
| Experiment | T5 | T4 | T3 | T2 | T1 | rpm | #/h | psig | psig |
| 1 | 160 | 160 | 110 | 0 | 0 | 50 | 1 | 8 | 3 |
| 2 | 160 | 160 | 110 | 0 | 0 | 50 | 2 | 52 | 50 |
| 3 | 160 | 160 | 110 | 0 | 0 | 100 | 2 | 42 | 39 |
| 4 | 160 | 160 | 110 | 0 | 0 | 100 | 3 | 47 | 45 |

The present disclosure has been described in terms of some specific embodiments. They are intended for illustration only, and should not be construed as being limiting in any way. Thus, it should be understood that modifications can be made thereto, which are within the scope of the disclosure and the appended claims. Furthermore, all of the patents, patent applications, articles, and texts which are mentioned above are incorporated herein by reference.

1. A method for recovering carbon dioxide (CO₂) from a gas stream, comprising the following steps:
reacting CO₂ in the gas stream with fine droplets of a liquid absorbent, so as to form a solid material in which the CO₂ is bound;
delivering the solid material to a transporting desorption unit;
conveying and processing the solid material in the transporting desorption unit to provide a decarboxylation reaction and release substantially pure CO₂ gas, the transporting desorption unit comprising a conveying section, a heating section, a second conveying section downstream of the heating section, a sealing section downstream of and adjacent to the second conveying section, a third conveying section downstream of the sealing section and a compression section downstream of the third conveying section, and wherein the heating section comprises one or more kneading blocks configured to provide heat to the solid material by viscous dissipation; and
collecting the CO₂ gas.

2. The method of claim 1, further comprising transporting any remaining solid material to a secondary desorption site and further processing the remaining solid material to release substantially pure CO₂ gas.

3. The method of claim 1, wherein reaction of the CO₂ with the fine droplets occurs in a spray tower, or in a venturi scrubber.

4. The method of claim 1, wherein the liquid absorbent comprises at least one amine compound.

5. The method of claim 1, wherein the solid material is a carbamate, a bicarbonate, or combinations thereof.

6. The method of claim 1, wherein the step of processing the solid material provides decarboxylation of a carbamate into a siloxane and CO₂.

7. The method of claim 1, wherein the transporting desorption unit is an extruder including an extruder barrel having disposed therein one or more screw mechanisms.

8. The method of claim 1, wherein the transporting desorption unit comprises an upstream section at atmospheric pressure and a downstream section at a pressure greater than atmospheric pressure, wherein the upstream section and the downstream section are separated by a sealing section including a hydraulic dynamic seal created by pushing the solid material against an interior surface of the transporting desorption unit, raising the pressure in the sealing section to a pressure greater than atmospheric pressure.

9. (canceled)

10. The method of claim 1, wherein the transporting desorption unit further comprises one or more vents configured to remove CO₂ produced by the decarboxylation reaction and permitting a liquid, partially depleted of CO₂, to be obtained.

11. The method of claim 1, wherein the processing the solid material in the transporting desorption unit further comprises:
conveying the solid material from a feed throat of the transporting desorption unit towards a die plate in the transporting desorption unit;
heating the solid material to regenerate a starting liquid siloxane and gaseous CO₂,
sealing the transporting desorption unit dynamically so an upstream atmospheric section can be decoupled from a downstream section at high pressure, and
pumping a siloxane-CO₂mixture out of the transporting desorption unit at a pressure greater than atmospheric pressure.

12. The method of claim 11, wherein the step of heating the solid material is carried out at a temperature sufficient to substantially decompose the solid material formed by the reaction of the CO₂ and the liquid absorbent.

13. The method of claim 1, wherein the processing the solid material in the transporting desorption unit further comprises processing a fine powder in an upstream section, processing a two-phase liquid-gas system in a downstream section, and processing a mixture of a solid, a liquid and a gas in an intermediate section of the transporting desorption unit where a decarboxylation reaction takes place.

14. The method of claim 1, wherein the transporting desorption unit further comprises one or more right-handed conveying (helical) elements and one or more left-handed conveying (helical) elements.

15. The method of claim 1, wherein the one or more kneading blocks include one or more right-hand kneading blocks, left-hand kneading blocks and neutral kneading blocks.

16. The method of claim 1, wherein processing the solid material in the transporting desorption unit regenerates at least a portion of the liquid absorbent, which is separated from the collected CO₂ gas.

17. The method of claim 16, wherein the regenerated liquid absorbent is directed back to a reaction site for reaction with additional CO₂ from the gas stream, to form additional solid material.

18. The method of claim 1, further comprising pumping a flow of extrudate via a positive displacement pump located downstream of the transporting desorption unit to make a flow of extrudate more uniform and generate additional pressure to feed a downstream desorption unit.

19. A method for recovering carbon dioxide (CO₂) from a gas stream, comprising the following steps:
reacting CO₂ in the gas stream with fine droplets of a liquid absorbent, so as to form a solid material in which the CO₂ is bound;
delivering the solid material to a transporting desorption unit; and
processing the solid material in the transporting desorption unit, to provide a decarboxylation reaction and release substantially pure CO₂ gas, the transporting desorption unit comprising a conveying section, a heating section, a second conveying section downstream of the heating section, a sealing section downstream of and adjacent to the second conveying section, a third conveying section downstream of the sealing section and a compression section downstream of the third conveying section, and wherein the heating section comprises one or more kneading blocks configured to provide heat to the solid material by viscous dissipation, wherein processing the solid material comprises:
conveying the solid material from a feed throat of the transporting desorption unit towards a the heating section in the transporting desorption unit;
heating the solid material in the heating section to regenerate a liquid siloxane and gaseous CO₂;
sealing the transporting desorption unit dynamically so an upstream atmospheric section can be decoupled from a downstream section at high pressure; and
pumping the liquid siloxane and gaseous CO₂ mixture out of the transporting desorption unit at a pressure greater than atmospheric pressure; and
collecting the CO₂ gas.

20. An apparatus for recovering carbon dioxide (CO₂) from a gas stream, comprising:
a reaction chamber suitable for reacting the CO₂ gas with a reactant, so as to form a solid material in which the CO₂ is bound; and
a transporting desorption unit configured to transport the solid material from the reaction chamber and provide a decarboxylation reaction therein and release substantially pure CO₂ gas and regenerate the reactant, the transporting desorption unit comprising a conveying section, a heating section, a second conveying section downstream of the heating section, a sealing section downstream of the second conveying section, a third conveying section downstream of the sealing section and a compression section downstream of the third conveying section, and wherein the heating section comprises one or more kneading blocks configured to provide heat to the solid material by viscous dissipation.

21. The apparatus of claim 20, further comprising at least one conduit for returning the regenerated reactant to the reaction chamber for reaction with additional CO₂ gas.

22. The apparatus of claim 20, further comprising a secondary desorption site downstream of the transporting desorption unit, wherein the secondary desorption site is configured to further process any remaining solid material to release substantially pure CO₂ gas.

23. The apparatus of claim 20, wherein the reaction chamber comprises a spray tower or a venturi scrubber.

24. The apparatus of claim 20, wherein the transporting desorption unit is an extruder including an extruder barrel having disposed therein one or more screw mechanisms.

25. The apparatus of claim 20, wherein the transporting desorption unit comprises an upstream section at atmospheric pressure and a downstream section at a pressure greater than atmospheric pressure, wherein the upstream section and the downstream section are separated by a the sealing section including a hydraulic dynamic seal created by pushing the solid material against an interior surface of the transporting desorption unit, raising the pressure in the sealing section to a pressure greater than atmospheric pressure.

26. (canceled)

27. The apparatus of claim 20, wherein the transporting desorption unit further comprises one or more right-handed conveying (helical) elements and one or more left-handed conveying (helical) elements.

28. The apparatus of claim 20, wherein the one or more kneading blocks include one or more right-hand kneading blocks, left-hand kneading blocks and neutral kneading blocks.

29. The apparatus of claim 20, further including a positive displacement pump located downstream of the transporting desorption unit and configured to make a flow of extrudate more uniform and generate additional pressure to feed a downstream desorption unit.
